(19) United States
(12) Patent Application Publication
(10) Pub. No.: US 2008/0201957 A1
(43) Pub. Date: Aug. 28, 2008

(54) DISPENSERS FOR RAZOR BLADE CARTRIDGES

(76) Inventor: Domenic V. Apprille, North Reading, MA (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 12/116,048

(22) Filed: May 6, 2008

Related U.S. Application Data
(62) Division of application No. 10/798,140, filed on Mar. 11, 2004.

(51) Int. Cl. B26B 11/00

(52) U.S. Cl. 30/124

(57) ABSTRACT

Dispensers are provided for razor blade cartridges used with a handle. The dispensers have a housing structure that defines sections for receiving respective cartridges and retaining the cartridges in predetermined positions that permit connection of a handle connecting structure on the handle to one of the cartridges as the handle is moved toward the cartridge. The dispensers also include a latch for each section. Each latch is shaped and positioned to interact with a corresponding feature on the blade unit of the cartridge.

### CROSS REFERENCE TO RELATED APPLICATION

This application is a divisional (and claims the benefit of priority under 35 U.S.C. § 120) of U.S. Ser. No. 10/798,140 filed on Mar. 11, 2004, which is incorporated herein by reference in its entirety.

### BACKGROUND

The invention relates to dispensing razor blade cartridges from a dispenser onto a handle.

Razor blade cartridges are typically removed from a dispenser by connecting the handle to the cartridge while the cartridge is still retained in the dispenser. The user then moves the handle with respect to the dispenser, using the leverage of the handle against a friction or interference fit of a projection that holds the cartridge body, and frees the cartridge from the dispenser.

### SUMMARY

In one aspect, the invention features, in general, a dispenser for razor blade cartridges used with a handle. The dispenser has a housing structure that defines sections for receiving respective cartridges and retaining the cartridges in predetermined positions that permit connection of a handle connecting structure on the handle to one of the cartridges as the handle is moved toward the cartridge. The dispenser also has a latch for each section. Each latch is shaped and positioned to interact with a corresponding feature on the blade unit of the cartridge.

In a first aspect, the invention features a dispenser for razor blade cartridges, each cartridge including a blade unit and a cartridge connecting portion for connecting the cartridge to a handle. The dispenser includes a housing structure including a base and angled cartridge dividers that define sections for receiving respective cartridges and retaining the cartridges in predetermined positions that permit connection of a handle connecting structure on the handle to one of the cartridges as the handle is moved toward the cartridge. Each section includes a latch shaped and positioned to interact with a corresponding resilient feature on the blade unit of the cartridge, the latch being sufficiently rigid to resist movement during removal of a cartridge from the dispenser.

In a second aspect, the invention features a combination including: (a) a cartridge dispenser including a housing structure that includes a base and dividers that define sections for receiving respective cartridges and retaining the cartridges in predetermined positions, each section comprising a latch that releasably holds a respective cartridge in a latched position within the section; and (b) a replaceable razor blade cartridge comprising a blade unit and a cartridge connecting structure for connecting the blade unit to a handle by movement of the handle toward the cartridge connecting structure, the blade unit including an elongated housing having a resilient latching portion for engagement by the latch on the cartridge dispenser.

Some implementations may include one or more of the following features.

Each section includes a pair of latches. The latches are positioned on inner surfaces of opposed side walls of the housing. Each latch includes a latch protrusion shaped to interact with a corresponding protrusion on the blade unit. The latch protrusion is positioned to retain the blade unit within the section by an interference fit with the blade unit protrusion. The latch protrusion includes an elongated ridge. The latch protrusion includes a notch. The latch protrusion includes a first surface positioned to inhibit vertical movement of the protrusion on the blade unit and a second surface positioned to inhibit horizontal movement of the protrusion on the blade unit. The ridge includes an elongated angled surface configured to facilitate insertion of a blade unit into the respective section. Each of the ridges extends vertically along, and is attached to, an inner side wall of the dispenser. The resilient latching portion includes an elastomer. The resilient latching portion further includes a raised portion of the housing structure underlying the elastomer.

The cartridge dividers include blade unit dividers that extend from the base, are generally perpendicular to the base, and define blade unit regions in which the blade units are received. The cartridge dividers further include angled dividers that extend from the ends of respective blade unit dividers at acute angles with the base and define angled regions through which the blade units pass during delivery to and removal from the blade unit regions and in which the cartridge connecting structure is received. An angled region of one section partially overlies a blade unit region of an adjacent section. The dispenser has drainage holes associated with respective sections.

The dispenser further includes raised members on which end structures of the cartridge are supported so as to avoid contact of the blades with the dispenser. Each of the raised members has a concave upper edge. An upper portion of the concave upper edge of each raised member is adjacent a lower portion of a convex surface of a corresponding one of the cartridge dividers.

The dispenser further includes a stabilizing feature, disposed on an upper edge of at least some of the cartridge dividers, constructed to engage the cartridge connecting portion and restrict movement of the cartridge connecting portion within an upper opening of the corresponding section. The dispenser further includes a feature, disposed on the upper edge, constructed to prevent contact between the stabilizing feature and a rear edge of the cartridge. The rear edge may include a trimming blade assembly. The upper edge is radiused to prevent contact between the stabilizing feature and the rear edge of the cartridge.

In another aspect, the invention features a method of using a replaceable razor cartridge including (a) storing a cartridge in a dispenser comprising a housing structure including a base and angled cartridge dividers that define sections for receiving respective cartridges and retaining the cartridges in predetermined positions, each section comprising a latch shaped and positioned to interact with a corresponding resilient feature on the blade unit of the cartridge, each latch being sufficiently rigid to resist movement during removal of a cartridge from the dispenser; (b) moving a handle connecting structure of a handle toward cartridge connecting structure of the cartridge to connect the cartridge to the handle; and (c) removing the cartridge from the dispenser while connected to the handle by retracting the handle from the dispenser.

The method may further include, after use of the razor, replacing the cartridge in the same or a different dispenser by moving the handle and connected cartridge into the dispenser, disconnecting the cartridge from the handle, and retracting the handle while the cartridge remains in the dispenser.

The invention also features a method of connecting a replaceable razor cartridge to a handle in a proper orientation, the cartridge including a blade unit and a cartridge connecting structure for connecting the cartridge to the handle, the method including (a) storing the cartridge in an angled region of a dispenser between a front angled divider and a rear angled divider that are generally parallel to each other, and (b) moving a handle connecting structure of a handle toward the cartridge connecting structure of the cartridge to connect the cartridge to the handle. The handle connecting structure and cartridge connecting structure include corresponding asymmetrical features that will interfere with each other when the handle is in an improper orientation, and mate when the handle is in a proper orientation.

In yet a further aspect, the invention features a method of making a dispenser for razor blade cartridges, including permanently connecting a bottom plastic part and a top plastic part that together define sections for receiving respective razor blade cartridges, the bottom part and/or top part including features configured to inhibit relative movement of the bottom and top part during and after the connecting step.

Embodiments of the invention may have one or more of the following advantages. Handles are easily connected to new cartridges, and the cartridges are readily unlatched from the dispenser after connection of the handle to the cartridge. The cutting edges of the blades of the razor, including a trimming blade if one is included, are protected from damage during insertion of the cartridge into the dispenser and removal of the cartridge from the dispenser. The use of blade unit regions and overlying angled regions provides for conserved space along the base of the dispenser and efficient placement of cartridges for a given peg space requirement for the dispenser. The user is prevented from connecting the handle to a cartridge in the wrong orientation due to asymmetrical features of the dispenser that provide a visual cue to prompt the user to properly orient the dispenser. The dispenser drains and vents well, allowing it to be used in a damp environment, such as the bathroom, without damage to the cartridges during extended storage.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a perspective view of a dispenser for razor blade cartridges. FIG. 1A is a perspective view of the dispenser, taken from a different angle, showing a cartridge in the dispenser. FIGS. 1B and 1C are enlarged detail views, in partial cross-section, showing a protrusion on the cartridge separate from and engaged with, respectively, a latch on the dispenser housing.

FIG. 2 is a perspective view showing a replaceable razor cartridge aligned with a handle on which the cartridge is connected for use. FIG. 2A is an enlarged front plan view of the cartridge shown in FIG. 2. FIG. 2B is an enlarged rear plan view of the cartridge shown in FIG. 2. FIG. 2C is a perspective view of the blade unit of the cartridge, with the blades omitted. FIG. 2D is an enlarged perspective view of the portion of the blade unit of FIG. 2C indicated by circled area D in FIG. 2.

FIG. 3 is a top plan view of the FIG. 1 dispenser.

FIG. 4 is a vertical sectional view, taken along line 4-4 of FIG. 3, of the FIG. 1 dispenser.

FIG. 5 is a perspective view of the bottom part of the FIG. 1 dispenser. FIG. 5A is a bottom plan view of the bottom part.

FIG. 6 is a vertical sectional view, taken along line 6-6 of FIG. 4, of the upper part of the FIG. 1 dispenser. FIG. 6A is a vertical section view of the upper part, taken along line 6A-6A of FIG. 4. FIG. 6B is an enlarged detail view of area B in FIG. 6, showing a single angled divider and latch of the FIG. 1 dispenser.

FIG. 7 is an exploded view of a handle connecting structure at the upper end of the FIG. 2 handle.

FIG. 8 is a sectional view of the end of the FIG. 7 handle connecting structure engaged with the cartridge connecting structure of the cartridge of FIG. 2. FIG. 8A is similar to FIG. 8, but shows the cartridge connecting structure only partially engaged.

FIG. 9 is an illustration showing the position of a FIG. 2 cartridge stored between dividers in a section of the FIG. 1 dispenser.

FIGS. 10-10C are illustrations showing the positions of the cartridge, dispenser components, and handle during connection of the handle to a cartridge in the FIG. 1 dispenser and removal of the connected cartridge from the dispenser.

FIG. 11 is a bottom plan view of the upper part of the dispenser. FIG. 11A is a sectional view taken along line 11A-11A in FIG. 11.

### DETAILED DESCRIPTION

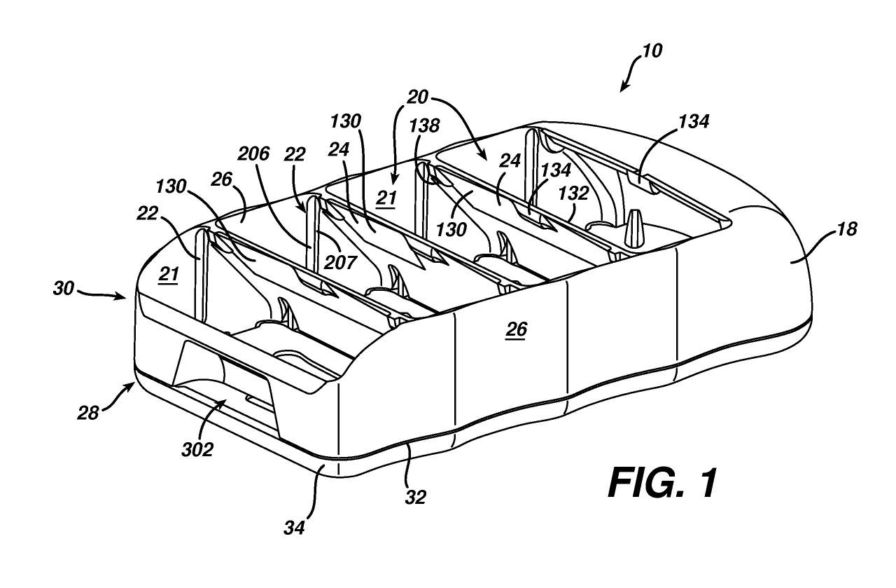

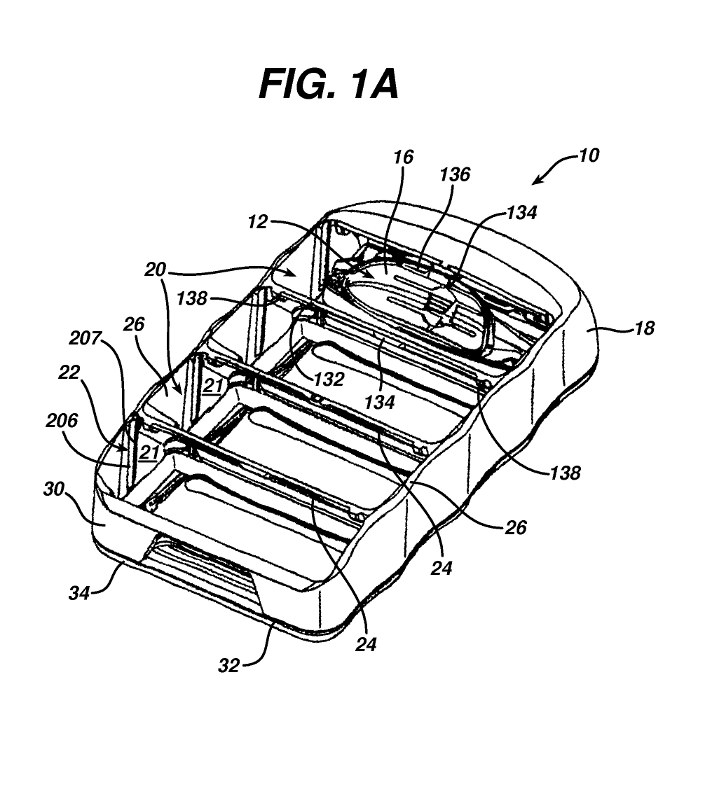

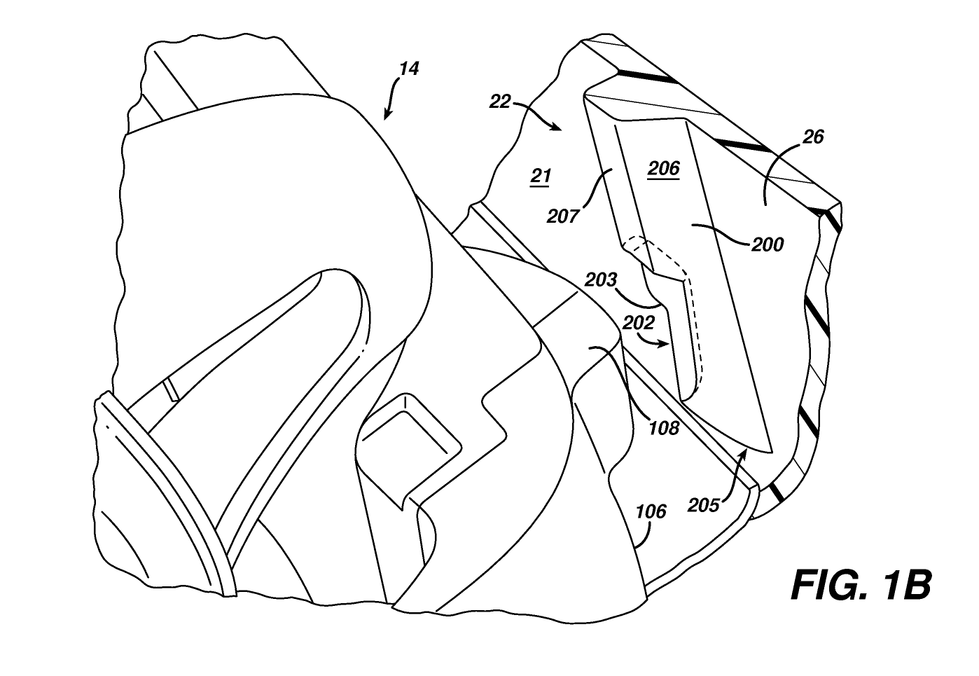

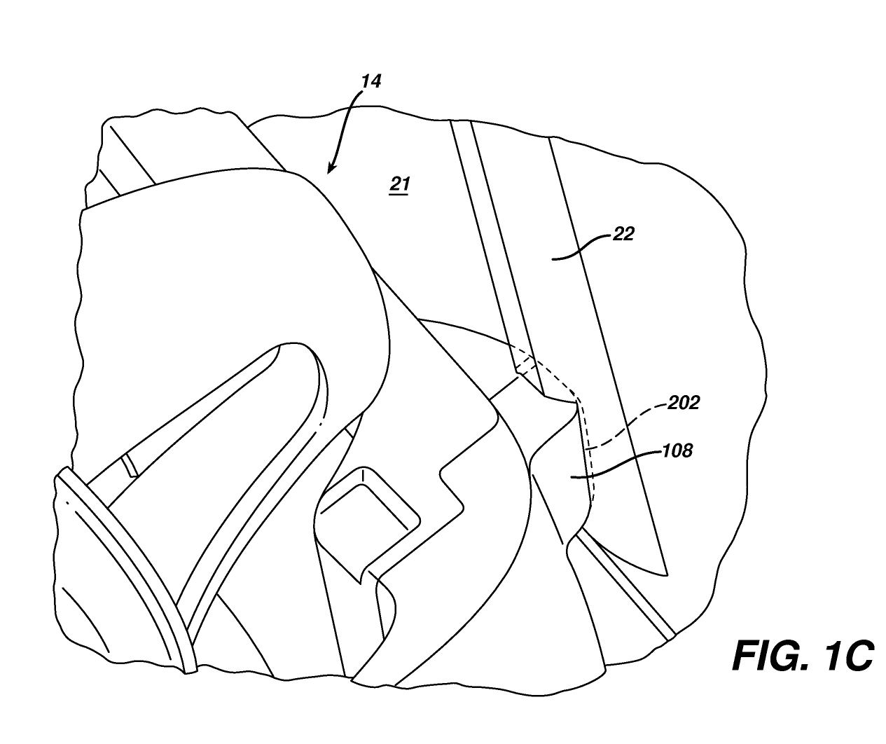

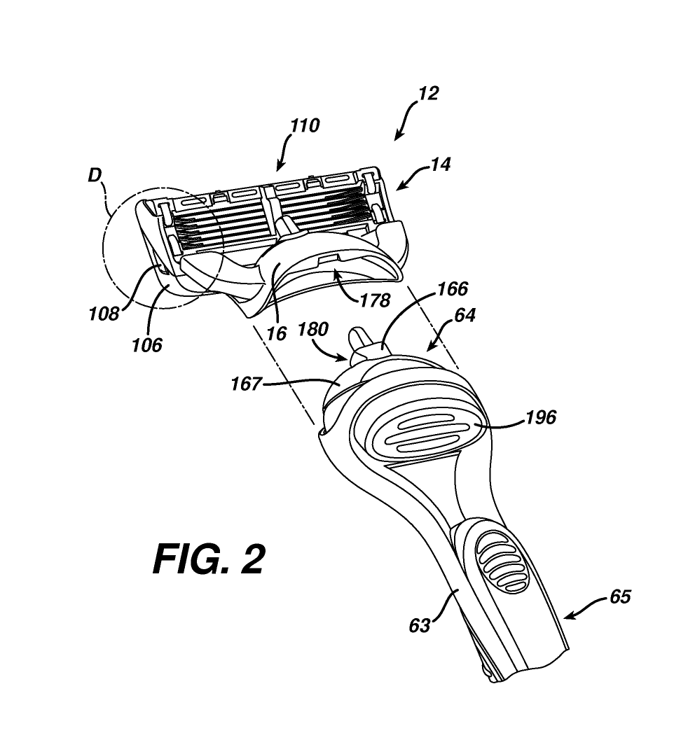

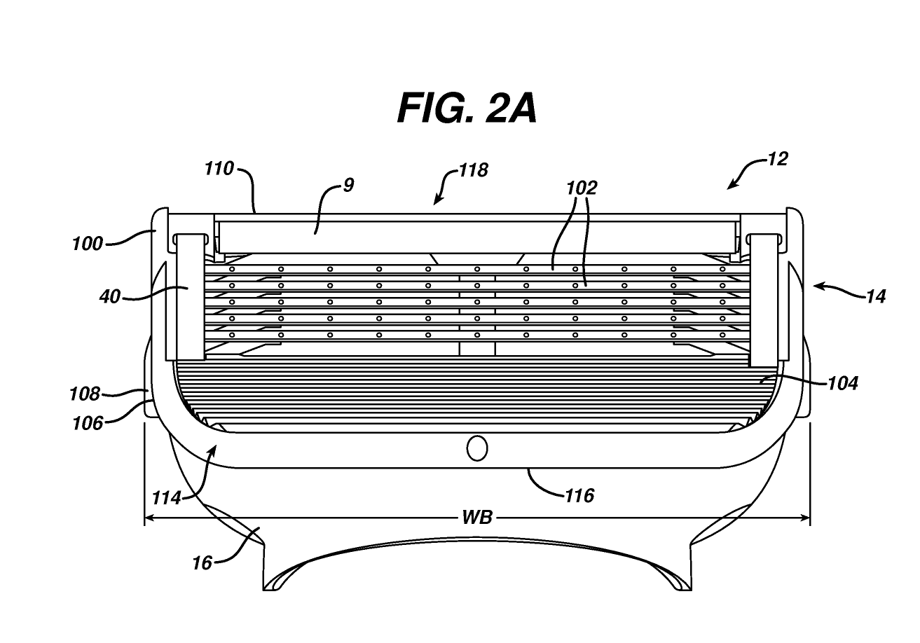

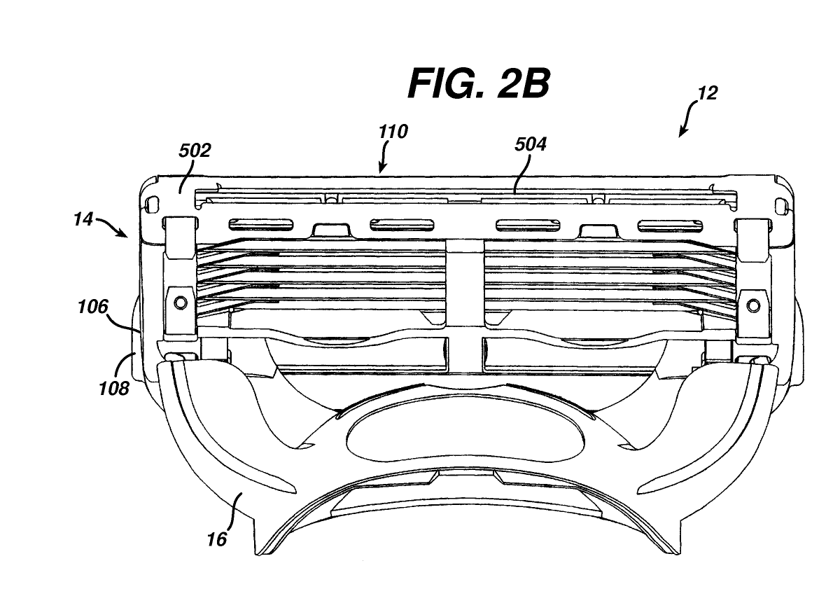

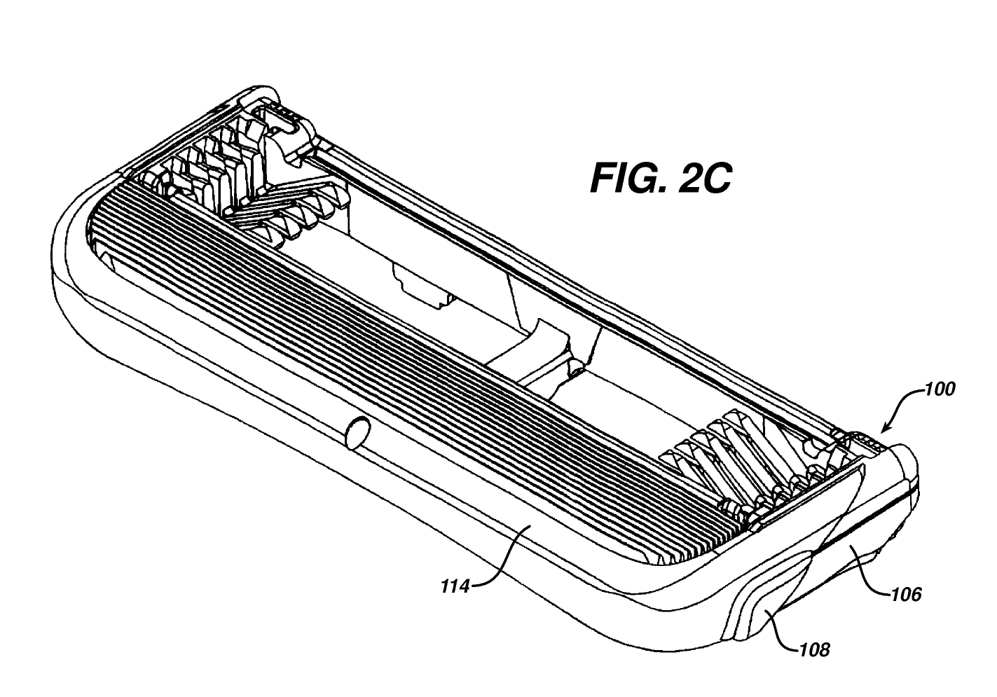

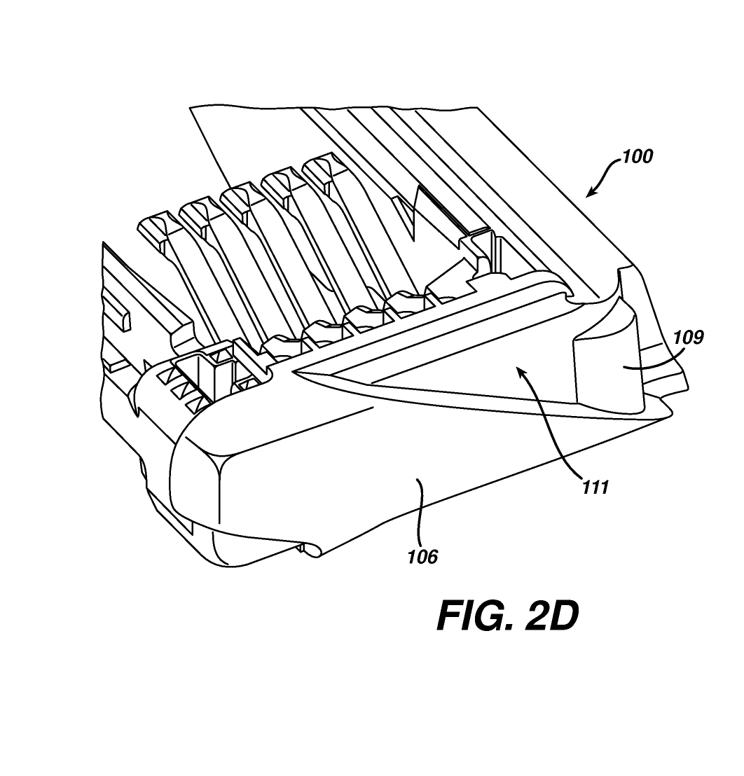

FIGS. 1-1A show a cartridge dispenser 10 (FIG. 1) for storing razor blade cartridges 12 (FIG. 2). Referring to FIG. 2, each razor blade cartridge 12 includes a blade unit 14 that is pivotally connected to a cartridge connecting structure 16. Cartridge connecting structure 16 is constructed to engage a handle connecting structure 64 disposed at the upper end of hand gripping portion 65 of the handle 63, as will be discussed in further detail below.

Referring to FIG. 2A, blade unit 14 includes a housing 100 constructed to hold a plurality of blades 102, a pair of clips 40 for maintaining cutting edges of the blades at a desired exposure, and an elastomeric fin guard 104 which extends across the length of the housing and around side walls 106 of the housing. Each of the side walls of the housing includes an elastomeric protrusion 108, the features of which will be discussed in detail below. These protrusions are configured to engage corresponding latches 22 on dispenser 10, as will also be discussed in detail below. The elastomeric fin guard is described in further detail in Ser. No. 10/799,938, filed concurrently herewith and entitled “Shaving Cartridges,” which is incorporated by reference as if fully set forth herein.

Referring to FIG. 2B, cartridge 12 also includes a trimming blade assembly 110, secured to the back of the housing, which includes blade carrier 502 and a trimming blade 504 mounted thereon. Blade carrier 502 may be made of, for example, 0.011″ thick stainless steel sheet metal that has been cut and formed. The blade carrier shown in FIG. 2B provides structures for supporting trimming blade 504 and defining a trimming guard and cap surfaces therefore and for attaching the trimming blade assembly to the housing. The trimming blade assembly is described in further detail in the applications incorporated by reference above.

The blade unit 14 also includes a lubricating strip 9 that provides a lubricious shaving aid and is received in slot at the rear of the housing. Lubricating strip 9 may be made of a material comprising a mixture of a hydrophobic material and a water leachable hydrophilic polymer material, as is known in the art and described, e.g., in U.S. Pat. Nos. 5,113,585 and 5,454,164, which are hereby incorporated by reference.

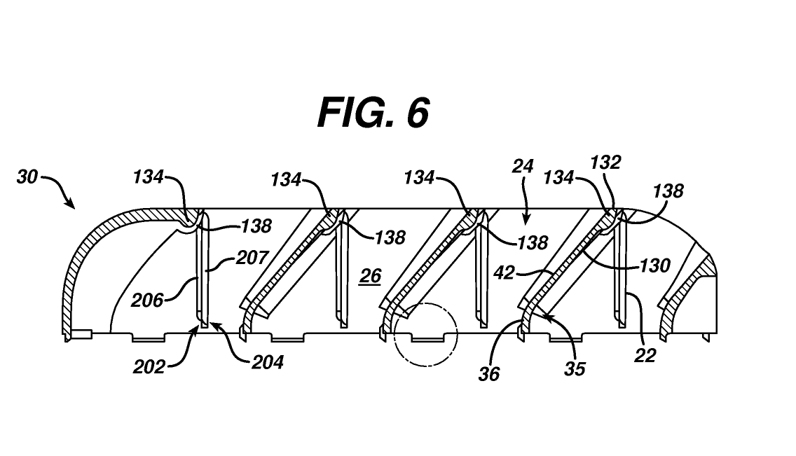

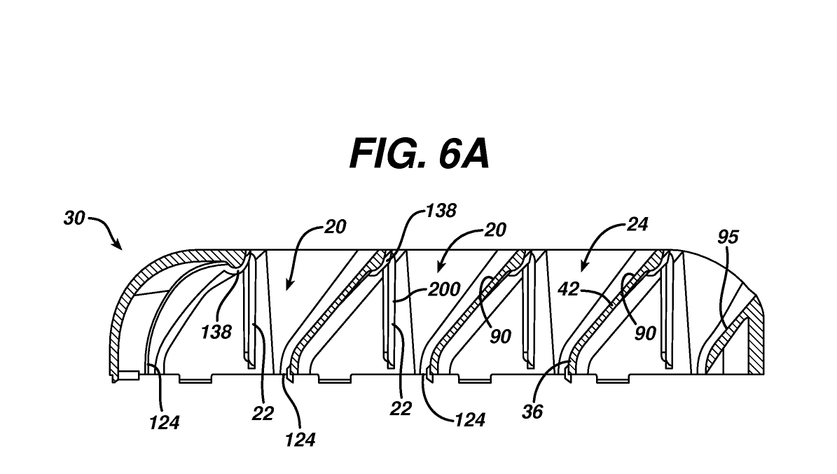

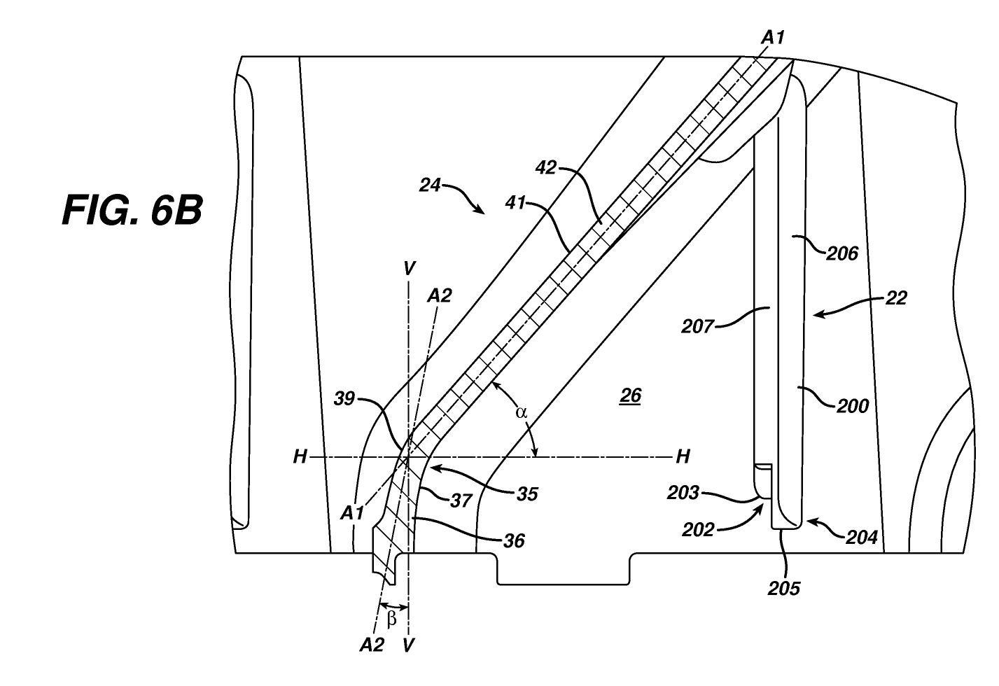

Referring now to FIGS. 1-1A, dispenser 10 includes a housing structure 18 that defines sections 20 for receiving cartridges 12. Each section includes a pair of latches 22, described in detail below, configured to engage the elastomeric protrusions 108 on the blade unit 14 and thereby retain each cartridge 12 in its respective section 20. Sections 20 are defined by cartridge dividers 24 and side walls 26 of housing structure 18. Referring to FIGS. 6-6B, each cartridge divider 24 includes a lower, generally perpendicular blade unit divider portion 36, at the bottom, and an upper angled divider portion 42 above it. The blade unit divider portion 36 and side walls 26 define a cavity dimensioned to receive the blade unit 14 of the cartridge.

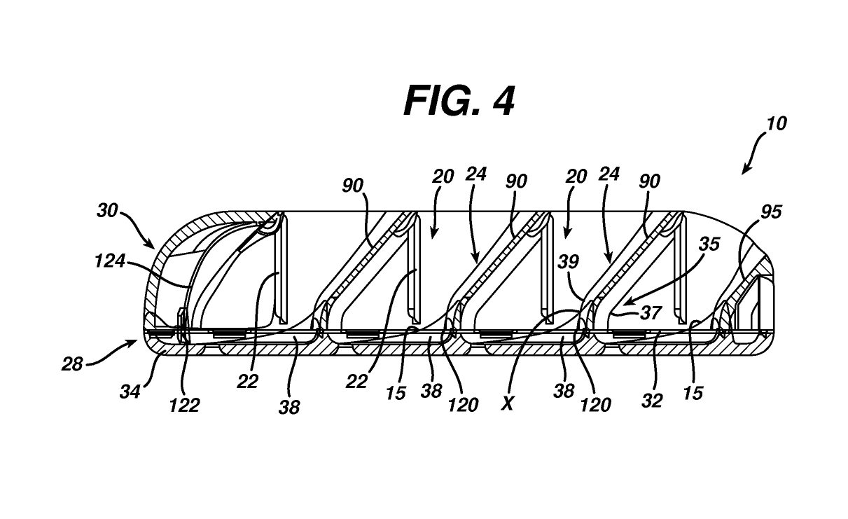

Dispenser 10 is generally manufactured by joining two molded parts, a bottom part 28 and an upper part 30 (e.g., by ultrasonic welding) at seam 32 (FIGS. 1 and 4).

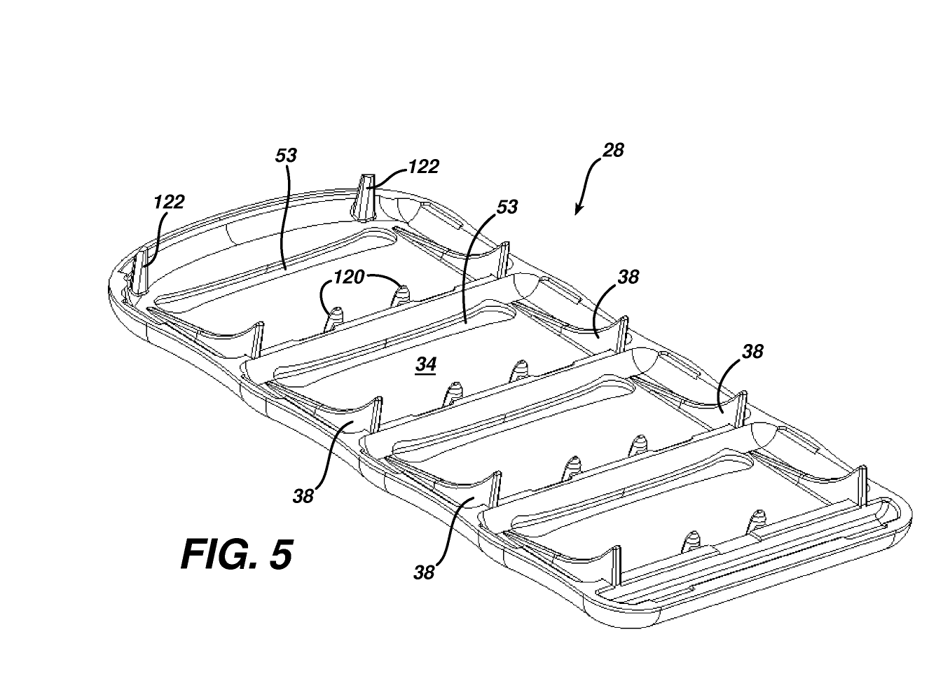

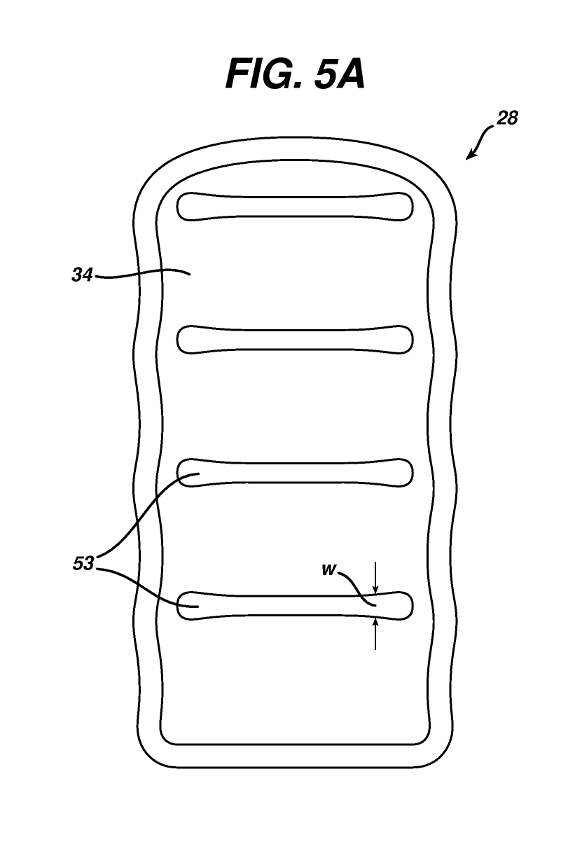

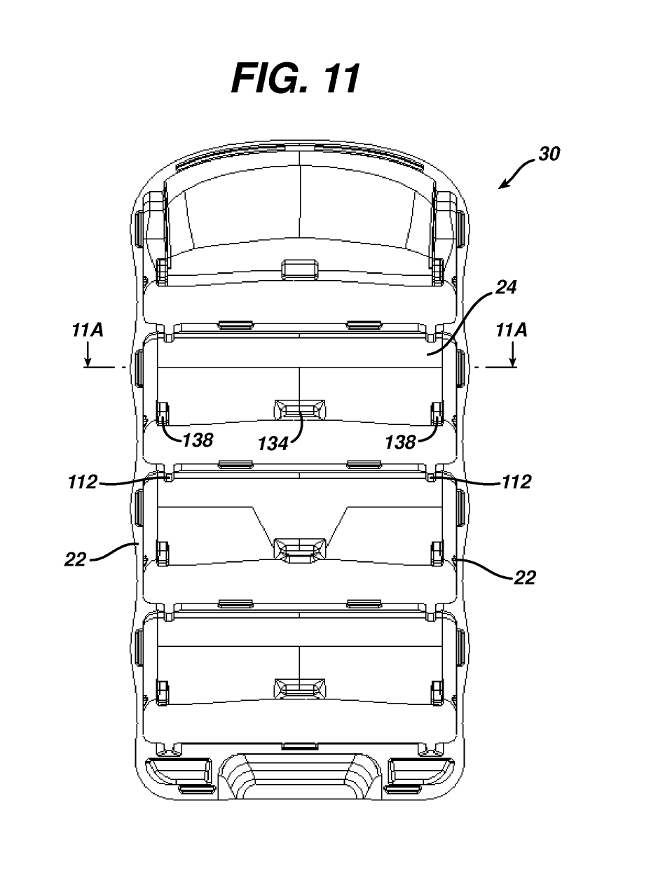

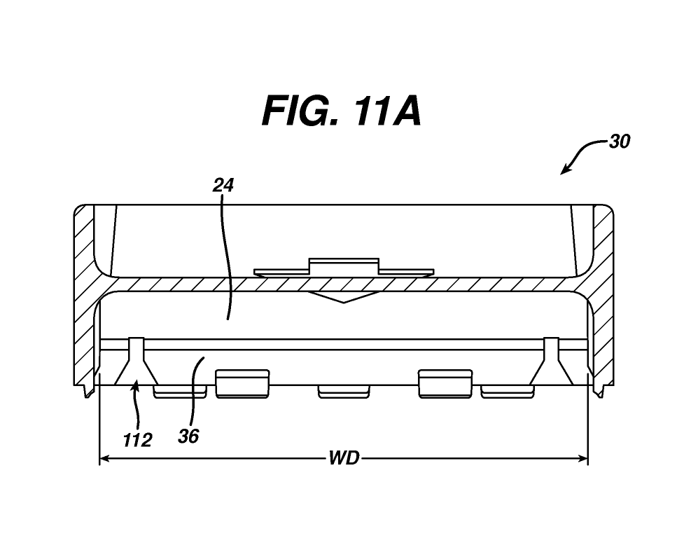

Referring to FIGS. 4 and 5, bottom part 28 includes a base 34 and a plurality of pairs of contoured cartridge supports 38 which extend upwardly from the base. The cartridge supports are arranged so that each section 20 of the assembled dispenser will include a pair of the supports. When the upper and bottom parts 28, 30 are assembled, as shown in FIG. 4, cartridge supports 38 are received by openings 112 (FIG. 11A) in the lower blade unit divider portions 36 of the upper part 30.

The cartridge supports 38 are positioned so that when a cartridge 12 is inserted in a section 20 the cartridge supports will be aligned with clips 40 at the ends of blade unit 14 (FIG. 2A), so as to avoid contact of the blades 102 with the cartridge supports 38. The cartridge supports 38 have a smoothly curved upper edge 15, having a concave curvature over which the clips of the blade unit can ride as the cartridge is inserted into and removed from the section 20.

Referring to FIG. 5A, base 34 also includes drainage openings 53 that are each associated with a section 20 for receiving a respective cartridge 12. These drainage openings are relatively large, e.g., have a width W of at least about 2.5 mm and a length approximately equal to (e.g., within about 5-15% of) the length of the strip 9, typically about 25-35 mm, so as to provide good drainage and drying of the cartridge. The openings may have areas of slightly larger width at their ends, as shown.

Referring to FIGS. 1-1A, 4 and 6, the upper part 30 includes the latches 22, which extend along the inner surface 21 of the side walls 26, and the angled dividers 24, which are connected to side walls 26 along the entire length of their side edges.

Latch 22, shown in detail in FIG. 6B, includes an elongated ridge 200 having a notched region 202 at its lower end 204. As shown in FIG. 1C, notched region 202 engages and compresses the elastomeric material of the protrusion 108 on the blade unit, retaining the protrusion in an interference fit. Engagement of the protrusion 108 with lower end 204 inhibits horizontal movement of the blade unit, while engagement with the bottom surfaces 203 and 205 of the notched region 202 and lower end 204, respectively, inhibits vertical movement. Thus, the engagement of the protrusion with the latch generally prevents the blade unit from slipping either backwards or upwards out of the section 20. The resilience of the elastomeric material allows the protrusion to be easily moved in and out of this interference fit by a force applied through the razor handle by a user, as will be discussed further below. Ridge 200 includes an angled surface 206 that slopes from the side wall 26 toward the front of the dispenser, and terminates in an adjacent flat surface 207 that extends generally parallel to the side wall. Angled surface 206, seen best in FIGS. 1A-1C, is provided to allow the protrusion 108 to slide past the ridge 200 when the cartridge is inserted into the section 20.

It is not necessary that the ridge 200 extend substantially the full height of the side wall 26, as shown. Instead, ridge may be replaced by a smaller raised feature (not shown) positioned in the vicinity of the notched region 202, as long as the raised feature provides a raised area that is sufficient to create an interference fit with the protrusion 108. However, it is generally preferred that the ridge be relatively long, as shown, as this facilitates molding. Providing a ridge 200 may also be preferred because angled surface 206 will tend to help guide the blade unit as it is inserted into the section 20.

Protrusion 108 consists of an underlying raised portion of the side wall of the housing and an overlying molded elastomeric protrusion covering the raised portion. The underlying raised portion 109 is shown in FIG. 2D, which shows the housing 100 without the elastomeric fin guard 104. The raised portion 109 is disposed in a recessed region 111 of the housing side wall 106 that is configured to receive a side portion of the fin guard 104. When the elastomeric material is applied to the housing to form the elastomeric fin guard, the elastomeric material is molded so that the elastomer that overlies the raised portion 109 defines the shape of the protrusion 108. This molded elastomer and the underlying raised portion 109 together provide the resilient characteristics of protrusion 108. In alternative embodiments, the underlying housing surface may be relatively flat (generally a recessed area will be provided, to accommodate the thickness of the side portions of the fin guard, but the raised portion 109 may be omitted if desired). In other alternative embodiments, the raised portion of the housing may extend further from side wall 106, and/or may have a different overall geometry, and the elastomer may be applied in a layer of uniform thickness that conforms to the shape of the underlying raised portion, rather than the elastomer being molded to define the shape of the protrusion 108.

The properties and dimensions of the protrusion 108 are generally selected to provide an interference fit between the blade unit and the dispenser that is sufficiently secure so that the blade unit does not slide out of the dispenser when the dispenser is moved or dropped, but that will allow the cartridge to be removed from the dispenser relatively easily by a user when the user attaches a handle to the cartridge and pulls back on the handle. For example, in preferred implementations, a cartridge will not fall out of the dispenser when the dispenser is dropped onto a hard surface from a height of 30 inches, both when the dispenser is initially held in a horizontal orientation (the long axis of the dispenser extending horizontally and the openings of sections 20 facing downwards) and when the dispenser is initially held in a vertical orientation (the long axis of the dispenser extending vertically).

The desired thickness of the elastomeric portion of the protrusion 108, and the overall height H of the protrusion (i.e., the furthest distance that the protrusion extends beyond the side wall 106 in a direction generally parallel to the long axis of the blades), will depend in part on the amount of resistance desired between the protrusion and the latch, the desired durometer of the elastomeric material (which will be influenced by other considerations such as user comfort, skin stretch and manufacturing constraints) and the geometry and position of the latch. Generally, as the interference provided by the geometry of the blade unit and dispenser is increased greater resilience of the protrusion will be required, in which case the thickness of the elastomeric portion would generally be increased.

The amount of interference will vary depending upon the difference between the protrusion-to-protrusion width of the blade unit (WB, FIG. 2A) and the latch-to-latch width of the dispenser (WD, FIG. 11A). The width WD of the dispenser is measured from the flat surface of one latch to the opposing flat surface of the opposite latch; the width WB of the blade unit is measured from the apex of the outer surface of the protrusion on one side to the apex of the outer surface of the protrusion on the opposite side. WB is greater than WD, creating an interference fit, as a result of the protrusions 108; the width of the blade unit without the protrusions (i.e., from one side wall 106 to the opposite side wall 106) must be less than WD so that the blade unit can slide smoothly in and out of the dispenser sections 20. Generally, WB is preferably from about 0.2 to 0.8 mm, or about 1 to 2% greater than the width WD. However, the difference between WB and WD may vary depending on the thickness and durometer of the elastomer, provided that WB is greater than WD.

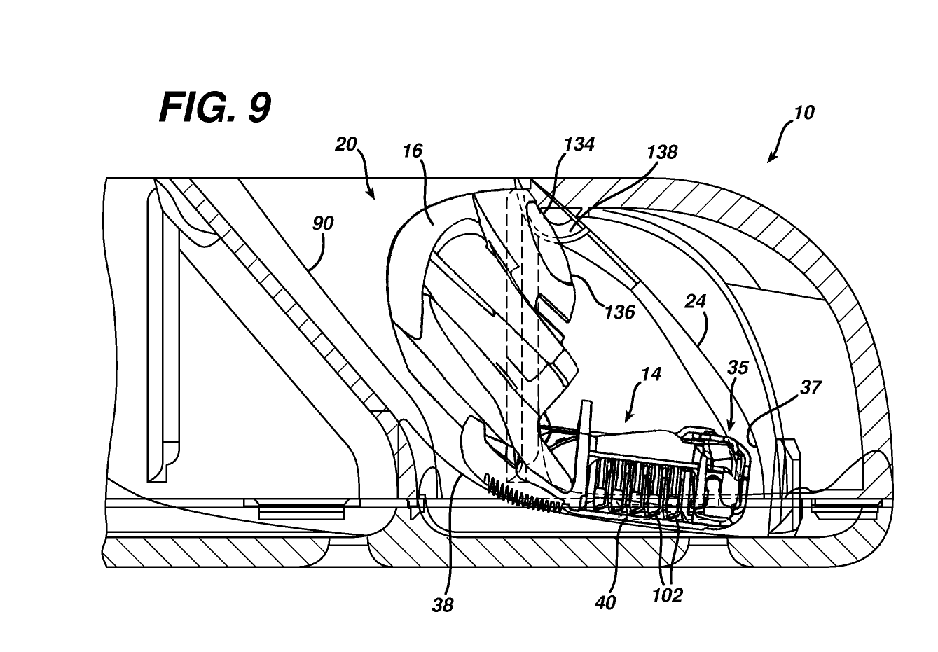

The width of the protrusion (i.e., the dimension measured in the direction of the short axis of the side wall 106) is selected so that the protrusion will contact the latch 22 in a manner so as to produce the desired interference fit. Typically, when the blade unit is in place in a section 20 as shown in FIG. 9, the top of the protrusion will be positioned at or above (preferably above) the bottom surface 203 of the ridge 200. The length L of the protrusion (measured along the long axis of the side wall 106) need only be sufficient to allow the protrusion to be engaged by the latch. The length L may be as long as desired.

The protrusion may have any desired shape, e.g., round, square, rectangular, diamond-shaped, etc., provided that the protrusion has a sufficient effective area to provide an interference fit with the latch. Preferably, the protrusion includes a smoothly tapered side surface, to facilitate insertion of the cartridge into the dispenser.

The angled dividers 24 have a geometry that allows the dispenser to store a relatively large number of cartridges for a given dispenser size, and that also allows cartridges to be securely stored in, yet easily removed from, the sections. Front wall 48 is similar in geometry and features to the angled dividers 24.

Referring to FIG. 6B, axis A1, extending through angled divider portion 42, is disposed at an angle α with respect to the horizontal (H). Preferably, angle α is no less than 43 degrees; a value of about 43-53 degrees, e.g., 48 degrees, provides a good balance between providing a sufficient number of cartridges in the lengthwise dimension of dispenser 10 (relating to peg space on a point of purchase display rack) and avoiding undue thickness for dispenser 10. Additional sections 20 for cartridges 12 could be provided by increasing the angle α to a higher angle, e.g., up to 90 degrees, but the height of the dispenser would be increased accordingly. A value of about 42 degrees is believed to provide a lower boundary permitting access to cartridge 12 given the angular orientation of blade unit 14 with respect to cartridge connecting structure 16, i.e., the extent to which blade unit 14 can pivot with respect to cartridge connecting structure 16.

Axis A2, extending through the generally perpendicular blade unit divider portion 36, forms an angle β with the horizontal. Angle β is preferably about 0 to 15 degrees, e.g., about 10 degrees. While divider portion 36 is generally slightly inclined toward the rear of the dispenser due to manufacturing constraints, portion 36 may be perpendicular to the base.

The region 35 at which portions 36 and 42 intersect provides a stop surface 37, inhibiting further forward or upward movement of a cartridge once the cartridge has been inserted into the respective section. Referring to FIG. 4, on the other side of the divider 24 the intersection of the concave surface 15 of the cartridge supports 38 with the convex curvature of surface 39 of the region 35 creates a discontinuity (area X, FIG. 4) that helps to push the front edge 116 of the blade unit 12 up onto surface 41 of the upper angled divider portion 42 as the cartridge is being withdrawn from the dispenser.

Selection of angle α, discussed above, affects the geometry of region 35 (discussed below) which provides a stop surface for the cartridge within section 20. Thus, if angle α is relatively large, the region 35 may not adequately inhibit upward movement of the cartridge.

Angled divider portions 42 include a substantially flat surface 90 over which the clips 40 of the blade unit can ride as the cartridge is inserted into or removed from a section 20. Because surface 90 is relatively flat (rather than bowed out in the center) the cutting edges of blades 102 will not contact the surface 90 during insertion and removal of the cartridge. Thus, the interaction of surface 90 with clips 40 and/or the housing protects the blade edges from contact and possible damage.

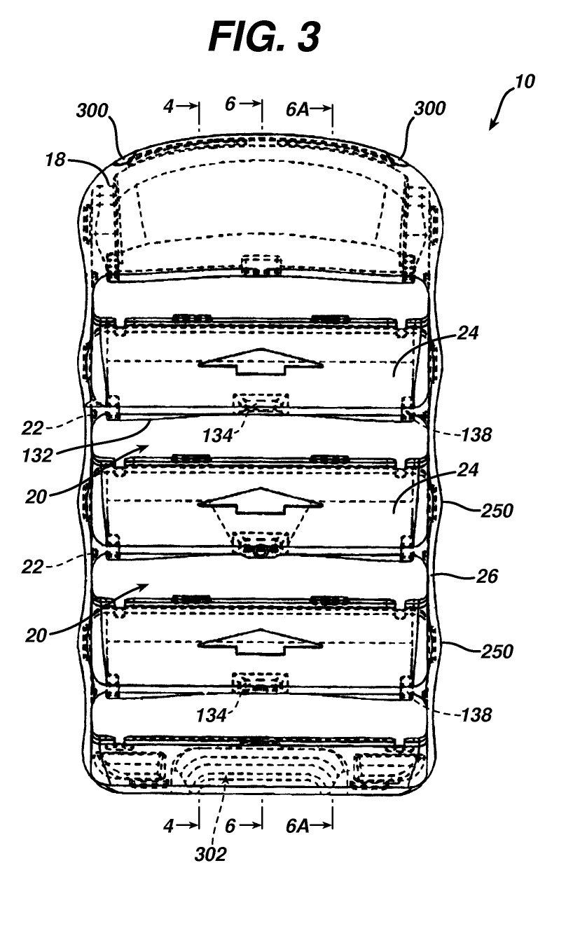

Referring to FIGS. 1 and 6, the inner surface 130 of each angled divider portion 42 includes several features adjacent the top edge 132 of the divider. A stabilizing feature 134 is centrally located along each top edge 132. Stabilizing feature 134 is constructed to abut the outer forward surface 136 of the cartridge connecting structure 16 when the cartridge is in the section 20, as shown in FIGS. 1A and 9. The stabilizing feature 134 inhibits movement of the connecting structure 16 along the long axis of the dispenser, reducing the angular rotation of the connecting structure 16 relative to the blade unit during movement of the dispenser. The stabilizing feature 134 also maintains the connecting structure 16 at a desirable angle for insertion of the handle connecting structure of a handle. A pair of raised ribs 138 are disposed adjacent each top edge 132, near the side walls 26. As shown in FIG. 6, these ribs 138 extend further from surface 130 than does the stabilizing feature 134. As a result, ribs 138 protect the trimming blade 504 from contact with the stabilizing feature 134 during insertion and withdrawal of the cartridge. Preferably, the ribs 138 extend at least 0.75 mm, preferably 0.85 to 1.0 mm, beyond the stabilizing feature in all directions. The top edge 132 is also preferably curved (FIG. 3) to minimize damage to the trimming blade.

The upper part 30 and/or the bottom part 28 may also include molded features that provide tactile and/or aesthetic qualities, e.g., molded waves 250 (FIG. 3) that extend vertically along the outer surface of side walls 26 to provide a gripping surface. Waves 250 may be arranged to nest with the waves of another dispenser that is rotated 180 degrees, to minimize the peg space and packaging materials required to package two dispensers side-by-side.

Bottom part 28 and upper part 30 also include cooperating features that help to maintain proper alignment of the upper and bottom parts prior to and during welding. For example, as shown in FIG. 5, bottom part 28 includes pairs of protrusions 120 that act as a stop to restrict movement of lower edges 124 of dividers 24 on upper part 30 (FIG. 6). These protrusions 120 help to align the upper and bottom parts, and also prevent the dividers 24 from deflecting forward in response to downward pressure that may be applied during a welding operation. Bottom part 28 also includes alignment pins 122 that abut the inner front surface 124 of the upper part 30 at the front corners thereof.

When a cartridge 12 is loaded into a respective section 20, the blade unit 14 is guided by upper surface 90 of divider 42 (or of back angled wall 95) and passes through angled region 35 into the blade unit receiving bottom portion of section 20. The side regions of blade unit 14 are also guided along the upper contoured surfaces of cartridge supports 38 and rest on supports 38. When insertion is complete, the rear edge of the blade unit (trimming blade assembly 110) comes to rest against surface 37 of blade unit divider portion 36. The cutting edge of the trimming blade 504 faces upward and thus does not contact the divider 24 when the blade unit is positioned in the section 20 (FIG. 9). As discussed above, the stabilizing feature 134 on each cartridge divider 24 holds the connecting portion 16 of the cartridge 12 in a desired position and inhibits movement of the connecting portion 16 after the cartridge is inserted into the section 20. FIGS. 1A and 9 show the position of cartridge connecting structure 16 in section 20 during storage and prior to connection to handle 63.

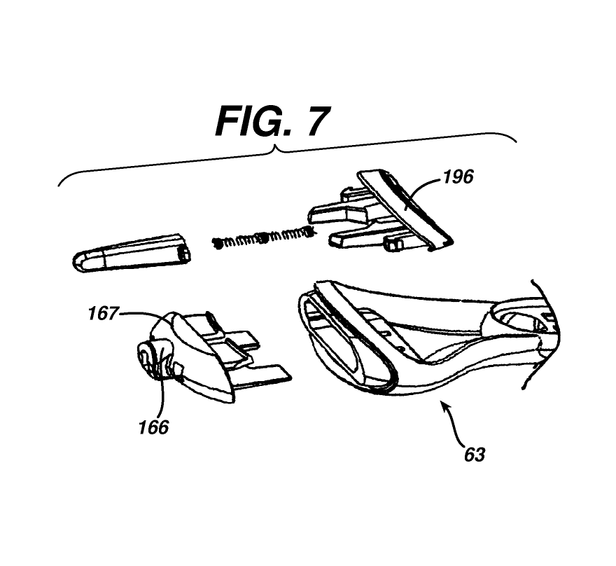

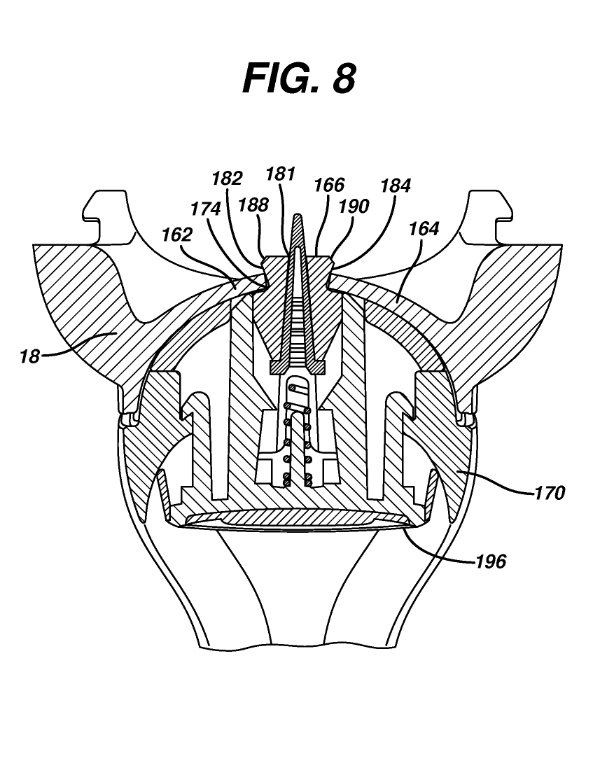

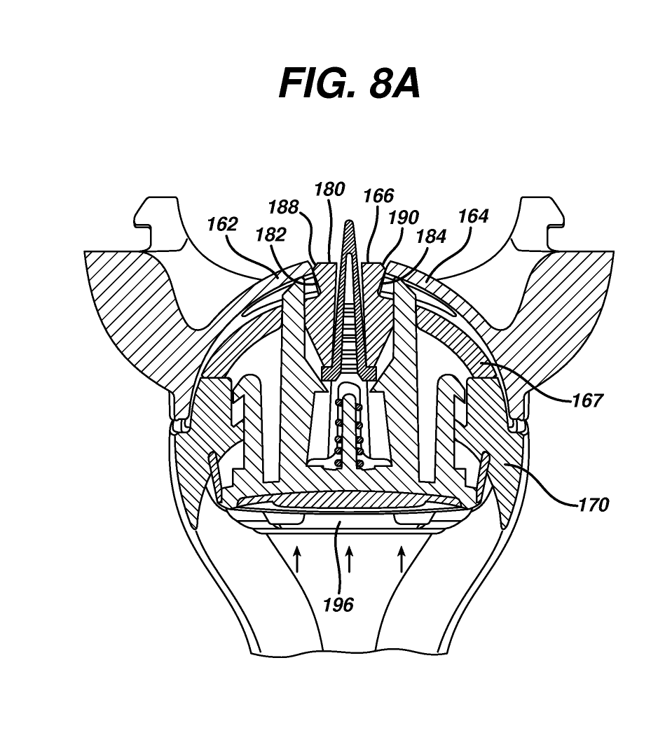

Referring to FIGS. 2, 7-8A and 10, to connect the cartridge to the handle, the user pushes the handle connecting structure 64 forward into the back end 178 of the cartridge connecting structure 16. The handle connecting structure includes a body 167 from which a projection 166 protrudes. Projection 166 is positioned to be received by an opening in the cartridge connecting structure 16 that is defined by the opposed edges of a pair of latches 162, 164 (FIGS. 8-8A) on the cartridge connecting structure. As the projection 166 is inserted into the opening, latches 162 and 164 elastically deflect to receive the distal end 180 of the projection 166. When the latches 162 and 164 clear outer edges 188 and 190 of the distal end 180 of the projection 166, the latches 162 and 164 recover toward their initial, undeflected position as they engage side surfaces 182 and 184 of the projection (FIG. 8).

Referring to FIG. 8A, to disconnect the cartridge from the handle, the user actuates a spring-biased release button 196 by pressing the button 196 forward relative to handle casing 170. Pushing button 196 forward extends pusher arms 192 and 194 into engagement with the latches 162 and 164. This engagement forces open the interference fit between the latches 162, 164 and the projection 166 to release the cartridge from the handle.

The details of the structure and operation of cartridge 12 and handle connecting structure 64 and the connection and disconnection of the cartridge 12 and handle 63 are described in Ser. No. 10/799,938, filed concurrently herewith and entitled “Shaving Cartridges,” which is incorporated by reference as if fully set forth herein.

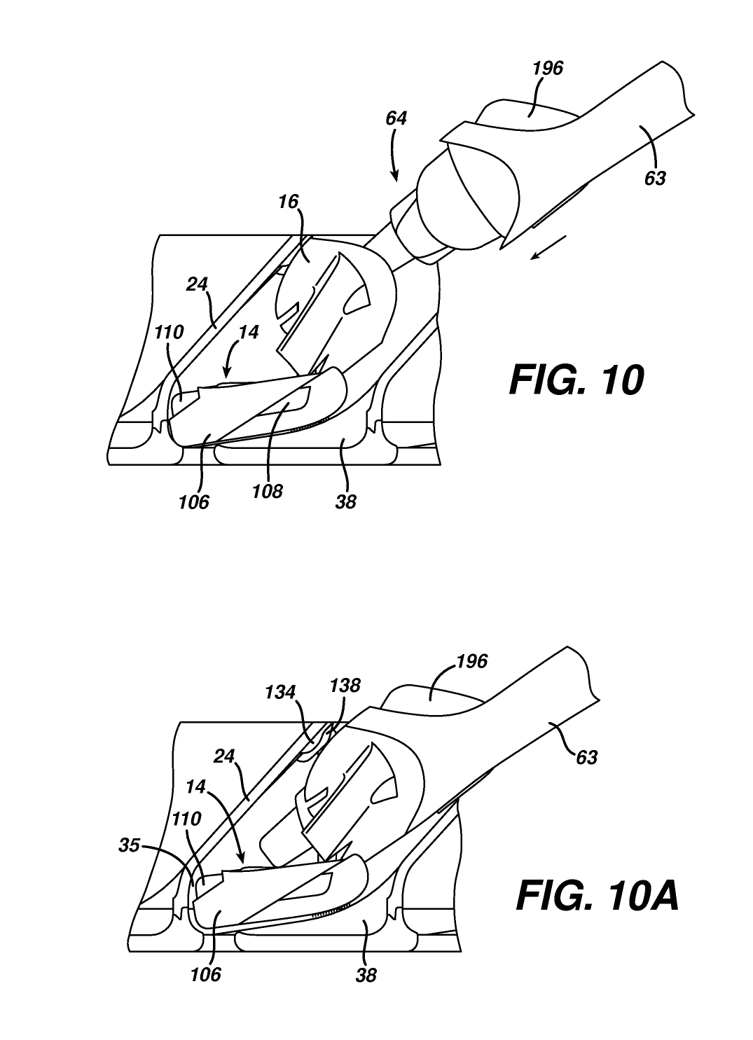

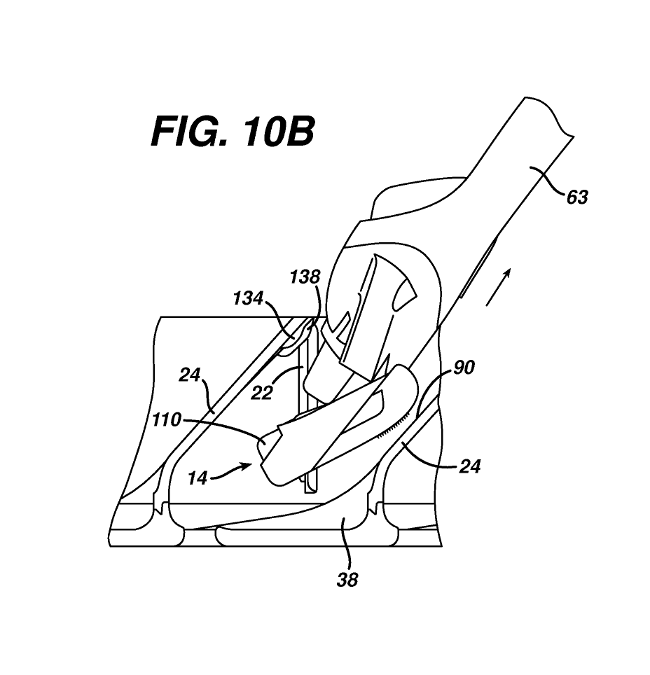

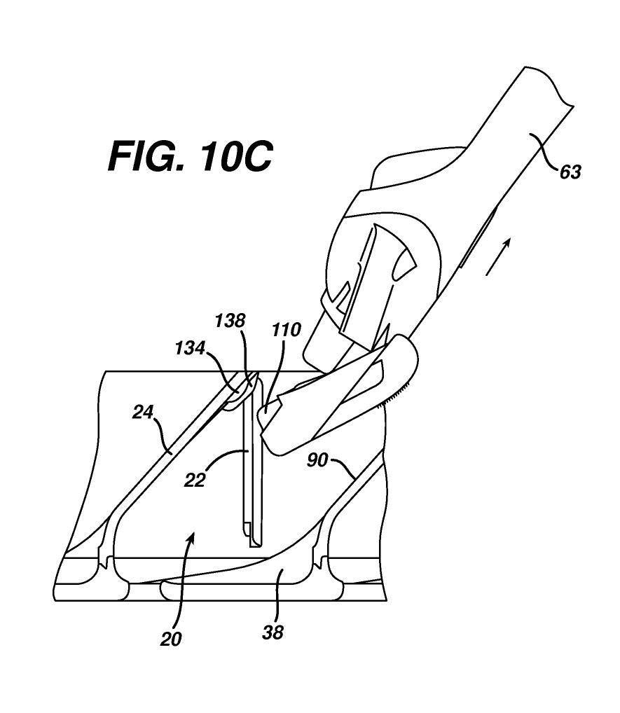

FIGS. 10-10C show various stages in the connection of the cartridge to the handle and removal of the cartridge from the section. When a shaver desires to replace a cartridge, the used cartridge is ejected from handle 63 using button 196 and discarded (or inserted into a vacant section 20 in a dispenser 10, as is discussed below). Then a new cartridge 12 in dispenser 10 is connected to handle 63 by engaging the connecting parts of the handle and cartridge in the manner discussed above (FIGS. 10-10A). The user then retracts handle 63 and connected cartridge 12 from dispenser 10, typically along the same axis along which the handle traveled during connection. The interference fit between the elastomeric protrusion 108 and the latch 22 is disengaged by the force exerted by the user pulling back and up on the handle 63. As the user continues to pull on the handle, cartridge 12 moves from the initially connected position of FIG. 10A to the initial retraction position of FIG. 10B and then the further retracted position of FIG. 10C. As the handle and connected cartridge move further outward from the position shown in FIG. 10C, trimming blade 504 passes stabilizing feature 134. As discussed above, stabilizing feature 134 is prevented from contacting the trimming blade 504 by ribs 138.

The user is prevented from connecting handle 63 to cartridge 12 in the wrong orientation owing to asymmetrical features of handle connecting structure 64 and cartridge connecting structure 16. For example, the contours of the body of the cartridge connecting structure and the body of the handle connecting structure are asymmetrically shaped, when viewed from the front, to assist the user in connecting the cartridge 12 to the handle 14 in the correct orientation. Thus, the body of the cartridge connecting structure may be generally D-shaped when seen from the front, and the body of the handle connecting structure may have a corresponding D-shape. These features prevent insertion of the handle connecting structure into the cartridge connecting part unless handle 63 is in the proper orientation (i.e., not upside down) regardless of whether the cartridge is in dispenser 10 or not.

The asymmetrical shape of housing structure 18 (i.e., rounded at the top and squared off at the bottom) also provides a visual cue to the user, helping the user to properly orient the dispenser prior to inserting a handle into a cartridge. The housing structure 18 may also include a logo or other indicia (e.g., the word “Cartridge” as shown in the figures, or a tradename or logo) to help the user to orient the dispenser.

When a user wishes to replace a cartridge 12 after it has been used for shaving, the cartridge can be returned to dispenser 10 by insertion along the same axis used during the connection step shown in FIG. 10, and ejection of the cartridge using button 196. As the user pushes forward and down during insertion, the protrusion 108 will automatically be engaged by latch 22, retaining the cartridge in place during retraction of the handle. Liquid on a used blade unit 14 stored in the dispenser 10 in this manner can drain through drainage holes 53 (FIG. 5).

The dispenser may include open areas 300, 302, at the front and rear, respectively (FIG. 3) constructed to receive corresponding features on a holder (not shown), such as an organizer tray.

A number of embodiments of the invention have been described. Nevertheless, it will be understood that various modifications may be made without departing from the spirit and scope of the invention.

For example, while the dispenser described above is formed by joining two molded parts, if desired the dispenser may be a single, integral part. Moreover, the stabilizing feature 134 and ribs 138 may be replaced by other features that will inhibit movement of the connecting structure and that will protect the trimming blade during removal.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of using a replaceable razor cartridge comprising
storing a cartridge in a dispenser comprising a housing structure including a base and angled cartridge dividers that define sections for receiving respective cartridges and retaining the cartridges in predetermined positions, each section comprising a latch shaped and positioned to interact with a corresponding resilient feature on the blade unit of the cartridge, each latch being sufficiently rigid to resist movement during removal of a cartridge from the dispenser;
moving a handle connecting structure of a handle toward cartridge connecting structure of the cartridge to connect the cartridge to the handle; and
removing the cartridge from the dispenser while connected to the handle by retracting the handle from the dispenser.

2. The method of claim 1 further comprising, after use of the razor, replacing the cartridge in the same or a different dispenser by moving the handle and connected cartridge into the dispenser, disconnecting the cartridge from the handle, and retracting the handle while the cartridge remains in the dispenser.

3. A method of connecting a replaceable razor cartridge to a handle in a proper orientation, the cartridge including a blade unit and a cartridge connecting structure for connecting the cartridge to the handle, the method comprising
storing the cartridge in an angled region of a dispenser between a front angled divider and a rear angled divider that are generally parallel to each other, and
moving a handle connecting structure of a handle toward the cartridge connecting structure of the cartridge to connect the cartridge to the handle,
wherein the handle connecting structure and cartridge connecting structure include corresponding asymmetrical features that will interfere with each other when the handle is in an improper orientation, and mate when the handle is in a proper orientation.

4. The method of claim 3, wherein the dispenser comprises a latch shaped and positioned to interact with a corresponding resilient feature on the blade unit of the cartridge located within the angled region of the dispenser.

5. The method of claim 4, wherein the latch is sufficiently rigid to resist movement during removal of a cartridge from the dispenser.

6. The method of claim 3 further comprising, after use of the razor, replacing the cartridge in the same or a different dispenser by moving the handle and connected cartridge into the dispenser, disconnecting the cartridge from the handle, and retracting the handle while the cartridge remains in the dispenser.
